(19) United States
(12) Patent Application Publication
(10) Pub. No.: US 2004/0031559 A1
(43) Pub. Date: Feb. 19, 2004

(54) Adhesive backing on end formed trim pieces

(76) Inventors: Avi Zohar, Thornhill (CA); Earlby Wakefield, Guelph (CA); Scott Mouser, Brampton (CA)

Correspondence Address: Robin W Asher, Clark Hill, Suite 3500, 500 Woodward Avenue, Detroit, MI, 48226-3435, US

(21) Appl. No.: 10/399,021

(22) PCT Filed: Oct. 12, 2001
(86) PCT No.: PCT/CA01/01435

(51) Int. Cl. B29C 47/02; B29C 47/34; B29C 47/00

(52) U.S. Cl. 156/244.19; 156/244.11; 156/247; 156/249; 156/244.24; 156/244.25; 156/498; 156/500

(57) ABSTRACT

Automotive trim strips (32) are made by extruding a thermoplastic material onto a foil carrier (24). The foil carrier (24) has a receiving surface having a low strength adhesive for releasably receiving the thermoplastic material (22). The thermoplastic material is end formed to contour ends of the thermoplastic material such that an automotive trim strip (32) is formed having a predetermined final length. The automotive trim strips (32) are then cooled. The foil carrier (24) is removed presenting a substantially flat surface for receiving adhesives for permanently attaching the automotive trim strip (32) to the vehicle.

### FIELD OF INVENTION

This invention relates to improvements in forming automotive trim strips utilizing an end forming process.

### BACKGROUND OF INVENTION

U.S. Pat. No. 5,904,884 describes a process for forming an extruded trim strip. The thermoplastic material is extruded onto an endless carrier belt. The extrudate is then end formed to provide a trim strip having a predefined length.

The described process is able to address the principal problem of forming a trim piece having a predetermined length after cooling. However, in order to maximize the throughput of the apparatus, the length of the endless belt must be minimized, otherwise, the capital cost of the apparatus presents an insurmountable barrier.

Further, in order to properly cool the formed end pieces, the cooling tank must be maximized, adding additional capital costs to the apparatus. If the trim pieces are not cooled properly, or removed from the endless belt too early, the ends of the trim pieces tend to curl at the ends. A trim piece which has curled ends is undesirable as such trim pieces will have a tendency to lift off the vehicle against the adhesive used to apply the trim piece thereto.

### SUMMARY OF THE INVENTION

The disadvantages of the prior art may be overcome by providing a method of forming automotive trim components by extruding a thermoplastic material onto a foil carrier having a low strength adhesive for releasably receiving the thermoplastic material. The foil carrier assists in maintaining the trim piece in a flat condition during the cooling process. Removing or peeling the foil carrier presents a substantially flat surface for receiving adhesives for attaching the automotive trim piece to the vehicle.

According to one aspect of the invention, there is provided a method for forming an automotive trim strip. The method includes steps of extruding a trim piece onto a foil carrier. The trim strip and foil carrier is then cooled. The foil carrier is removed presenting a substantially flat surface for receiving a permanent adhesive for attaching the trim strip to a vehicle. The foil carrier has a receiving surface having a low strength adhesive for releasably bonding the trim piece onto the foil carrier.

According to another aspect of the invention, there is provided an apparatus for making an automotive trim strip. The apparatus has an extruder producing an extrudate of a predetermined cross section. A roll carries a foil carrier having a receiving surface having a low strength adhesive releasably bonding the extrudate onto the foil carrier. A conveyor system transports the foil carrier from the extruder in order to receive the extrudate, through a cooling chamber to a cutter. A controller coordinates the speed of extrusion and the transport and the timing of the cutter.

### DESCRIPTION OF THE DRAWINGS

In drawings which illustrate the embodiments of the present invention,

FIG. 1 is a schematic of the method of the present invention.

### DESCRIPTION OF THE INVENTION

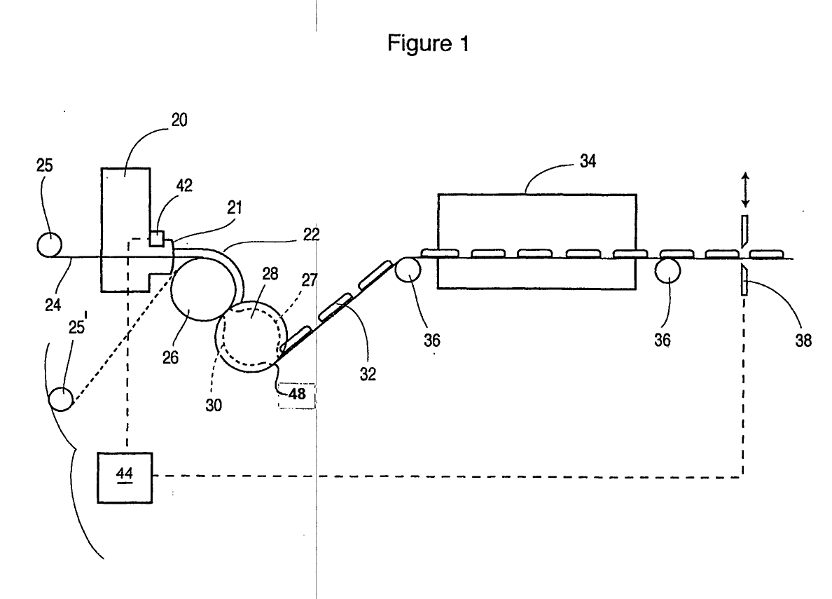

FIG. 1 illustrates a method of forming an extruded trim strip according to the invention which is formed on a foil carrier which moves consistently at a speed to minimize stresses on the softened plastic material.

Plastic material, for example polyvinylchloride, is extruded from an extrusion die 20. Extrusion die 20 may have a profile designed for a chosen profile of trim strip. Extrudate 22 emerges from extrusion nozzle 21 of die 20 under pressure from within the die. The extrusion nozzle 21 may have a shape to produce trim strip having a desired profile.

A foil carrier 24, preferably made of stainless steel having a thickness of about 0.25 to 0.5 mm unrolls from roll 25 and passes through the extrusion die 20 to emerge with the extrudate 22 and to pass, together with the extrudate 22 between a supporting idler wheel 26 and a molding periphery 27 of a forming wheel 28. Alternatively, aluminum foil of about 0.5 to 0.75 mm could also be used.

Optionally, the roll 25′ is positioned to feed the foil carrier 24 immediately after the extrusion process. The extrudate 22 is fed directly onto the foil carrier 24.

The surface of foil carrier 24 which receives the extrudate 22 has a low strength adhesive applied thereto. Low strength means an adhesive which will not permanently bond the extrudate 22 to the foil carrier 24, nor leave a residue on the formed trim strips 32 after removal of the foil carrier 24. The foil carrier 24 can be peeled off of the extrudate. Properties of a suitable adhesive are governed by time, pressure and temperature of the application of the adhesive to the extrudate 22.

The forming wheel 28 has at least one mold cavity 30 in its periphery. In this case the shape of extrusion nozzle 21 may not be of major importance since it is possible to mold the whole trim strip in the cavity 30. Alternatively forming wheel 28 may have projections 48 to pinch form endless portions against the supporting idler wheel 26 without bearing on the intermediate portion of the trim strip. As the extrudate 22 and foil carrier 24 emerge from the extrusion die 20, the extrudate 22 lies above and is carried by the foil carrier 24. The foil carrier 24 passes around the periphery of idler wheel 26 carrying the extrudate 22 radially outwards of it so that extrudate 22 is sandwiched between the foil carrier 24 lying against the periphery of idler wheel 26 and molding periphery 27 of forming wheel 28. Forming wheel 28 has a profiled cavity 30 around its perimeter. The cavity 30 forms a trim strip 32 of the desired profile. The cavity 30 has a length greater than the eventual length of cooled trim strip 32 by an amount calculated to allow for shrinkage. This amount is relatively easy to determine by measurement in a stable process.

The foil carrier 24 is driven to travel at the speed at which extrudate is forced out of the extrusion die 20 and continues throughout its length at the same speed thereby minimizing or eliminating downstream stresses on the softened extrudate 22 as it is processed by downstream equipment such as forming wheel 28.

Foil carrier 24 carrying trim strips 32 which are still soft emerge from the channel of forming wheel 28 and pass through a cooling tank 34. Various rollers 36 define the path of conveyor system for moving foil carrier 24.

The foil carrier 24 still carrying trim strips 32 emerges from cooling tank or chamber 34. The foil carrier 24 is then cut between the trim strips 32 by cutter 38. The individual trim strips 32, with segregated foil carrier 24 can then be placed in racks to allow the trim strips 32 and foil carriers 24 to stand and cool to room temperature. Once cooled, the segregated foil carrier 24 may then be removed. The undersurface of the trim strip 32 on which the foil carrier 24 was adhered, is surprisingly flat and smooth. Since the trim strip 32 was cooled prior to removal, the ends of the trim strip 32 remain in a flat condition. As is well known in the art, an adhesive or double sided tape is applied to the underside of the trim strip 32 for permanent attachment to the vehicle.

Speed sensors 42 may be provided at the nozzle of the extrusion die 20. Signals from the speed sensors may be fed to computer 44 which provides control signals to control the speed of the forming wheel 28 and the cutter 38.

The invention has been described in an illustrative manner, and it is to be understood that the terminology which has been used is intended to be in the nature of words of description rather than of limitation. It is now apparent to those skilled in the art that many modifications and variations of the present invention are possible in light of the above teachings. It is, therefore, to be understood that the invention may be practiced otherwise than as specifically described.

What is claimed is:

1. A method for forming an automotive trim strip comprising the steps of
extruding a trim piece onto a foil carrier, said foil carrier having a receiving surface having a low strength adhesive for releasably bonding the trim piece onto the foil carrier;
cooling the trim strip and foil carrier; and
removing the foil carrier presenting a substantially flat surface for receiving a permanent adhesive for attaching the trim strip to a vehicle.

2. A method as claimed in claim 1 wherein said extruding step comprises extruding a thermoplastic material through an extrusion die of an extruder.

3. A method as claimed in claim 2 wherein said method includes a step of feeding said foil carrier through said extruder.

4. A method as claimed in claim 2 wherein said method includes a step of feeding said foil carrier about an idler wheel and positioning said foil carrier to receive said thermoplastic material being extruded from said extruder.

5. A method as claimed in claim 3 or 4 wherein said method includes a step of end forming the trim piece after being extruded to contour ends thereof to provide the trim strip with a predetermined final length after said cooling step.

6. A method as claimed in claim 5 wherein said feeding of said foil carrier is at a speed corresponding with a speed of said thermoplastic material being extruded from said extruder.

7. A method as claimed in claim 6 wherein said method further includes a step of cutting said foil carrier at lengths carrying an individual one of said trim pieces.

8. A method as claimed in claim 7wherein said cooling step includes travelling said trim strip and foil carrier through a cooling chamber.

9. A method as claimed in claim 8 wherein said cooling step further includes allowing said trim strip and foil carrier to stand and cool to room temperature.

10. A method as claimed in claim 9 wherein said foil has a thickness of between 0.25 mm and 0.75 mm.

11. A method as claimed in claim 10 wherein said foil is aluminum having a thickness between 0.5 mm and 0.75 mm.

12. A method as claimed in claim 10 wherein said foil is stainless steel having a thickness of between 0.25 mm and 0.5 mm.

13. A method as claimed in claim 9, wherein said thermoplastic material is polyvinylchloride.

14. An apparatus for making an automotive trim strip comprising
an extruder having a die for producing an extrudate of a predetermined cross section;
a roll carrying a foil carrier having a receiving surface having a low strength adhesive releasably bonding the extrudate onto the foil carrier;
a cooling chamber;
a cutter; and
a conveyor system comprising a series of idler wheels and rollers for transporting said foil carrier from said extruder in order to receive said extrudate, through said cooling chamber to said cutter;
a controller operably connected with said extruder, conveyor system and said cutter to coordinate a speed of extrusion, a speed of said transport and timing of said cutter.

15. An apparatus as claimed in claim 14 wherein said apparatus further comprises a forming wheel cooperating with one of said idler wheels for end forming said extrudate as said extrudate emerges from said extruder thereby forming a trim strip.

16. An apparatus as claimed in claim 15 wherein said cutter is positioned to cut said foil carrier at lengths to carry an individual one of said trim pieces.
